(19) United States
(12) Patent Application Publication
(10) Pub. No.: US 2002/0178099 A1
(43) Pub. Date: Nov. 28, 2002

(54) Methods and systems for managing a portfolio of securities

(76) Inventor: Shayne Young, Austin, TX (US)

Correspondence Address: ERIC B. MEYERTONS, CONLEY, ROSE & TAYON, P.C., P.O. BOX 398, AUSTIN, TX, 78767-0398, US

(21) Appl. No.: 09/866,500

(22) Filed: May 25, 2001

(51) Int. Cl. G06F 17/60

(52) U.S. Cl. 705/36

(57) ABSTRACT

Methods and systems for managing a portfolio of securities are provided. In one embodiment, the portfolio of securities may include at least one entry transaction for at least one security. Each entry transaction may include an entry price. The method may include receiving an exit order for a portion of the portfolio. The exit order may include an exit price. The method may include determining a difference between the exit price and the entry price for each security in the portfolio. In addition, the method may include selecting a security to be included in the portion. The selected security may have a determined difference less than or equal to a determined difference of each other share of the security in the portfolio. The method may also include sorting the portfolio of securities according to entry price. The shares of the security in the portfolio may be exited according to sort order.

### BACKGROUND OF THE INVENTION

1. Field of the Invention

The present invention generally relates to computer software. Certain embodiments relate to computer-implemented systems and methods for managing securities (e.g., stocks, options contracts, futures, bonds, mutual funds, and other investments).

2. Description of the Related Art

The securities trading industry has burgeoned since the advent of the Internet. Many companies offer securities trading services through a variety of automated systems, such as a telephone or computer system. In recent years, Internet technology has significantly reduced the costs to trade securities for a typical investor. The lower cost of trading securities and the ability to trade in real-time using Internet based technology has spawned a new generation of investors, e.g., day traders. As used herein, “real-time” indicates a response to stimuli within some relatively small upper limit of response time (e.g., seconds or minutes).

Placement of orders to buy or sell securities using Internet technology may be done through the use of an order entry screen on a computer system. As used herein, a “security” generally refers to an investment instrument, issued by a corporation, government, or other organization, which offers evidence of debt or equity (e.g., stocks, options contracts, futures, bonds, mutual funds, and other investments). As used herein, a “portfolio” of securities includes one or more securities grouped together. The portfolio of securities may include similar or dissimilar securities. As used herein, “management” of a portfolio may include functions such as making buy/sell decisions regarding one or more securities, monitoring securities, conducting research on securities, and/or specifying particular securities to be included in the portfolio.

A day trader may use software tools, which may be useful in making both short-term investing decisions as well as intra-day trading decisions. An active day trader may buy or sell tens of thousands of shares during the same trading session. It may not be uncommon for the day trader to seek fractional gains per share for an intra-day trade. For example, a day trader may purchase 1000 shares of a particular stock at $25 per share and may sell the same 1000 shares of the particular stock a few minutes later when the stock price reaches $25.50 to make a profit of $500 before fees and commissions. Thus, software tools which provide information in real-time and software tools which assist in making buy/sell decisions in real-time may be important to the day trader to manage a portfolio of securities.

More particularly, it may be desirable to manage a portfolio of securities by managing the inventory of shares of a particular stock to optimize profits. Presently, it may be common to use a first-in-first-out (FIFO) inventory management method to manage the portfolio. For example, the FIFO method may automatically select shares which were bought first to fill a sell order. The FIFO method may be deployed as a default for position exiting transactions. In this manner, a day trader may be provided with little or no choice in selecting particular shares from an inventory of shares to fill an exit order. Therefore, such a default method may potentially overlook and reduce the overall portfolio profits.

Accordingly, it may be desirable to provide a system and method for managing an inventory of shares of a particular stock by exiting shares from the inventory in a particular order to optimize overall portfolio profits for a trader. For example, it may be desirable to select a particular portion of the inventory for a sell transaction to maximize profits or losses according to preferences of the trader. Moreover, because the quantity of securities related information available to traders may be overwhelming, it may be also desirable to provide a system and method to allow a trader of securities to customize a display of buy/sell transaction data in real-time.

### SUMMARY OF THE INVENTION

An embodiment of the invention relates to methods and systems for managing a portfolio of securities. The securities may include, for example, a stock, an option contract, a futures contract, a bond, a mutual fund, a treasury bill, cash and a Certificate of Deposit (CD). In one embodiment, a computer system may be configured to manage a portfolio of securities such that securities may be bought or sold. For example, the computer system may be configured to execute securities transactions such as buy orders or sell orders for securities. A trader may manage a portfolio of securities by executing buy or sell orders on the computer system. In one embodiment, an owner of a portfolio of securities may transfer a portion of the portfolio to a trader for managing the securities included in the portfolio.

The portfolio of securities, which may include at least one security, may include at least one position opening (e.g. “entry”) transaction of the security. An entry transaction may be either a buy or a sell transaction. In one embodiment, the portfolio, including each transaction for each security, may be displayed on a display screen coupled to the computer system. In one embodiment, the display of the portfolio may include a real-time summary of all buy and sell transactions executed during a trading session.

Each buy transaction may include a buy price, a buy quantity, a buy transaction date and a buy transaction time. Additional buy transaction attributes may include a unique symbol to identify the security, a symbol to identify the stock exchange where the security was bought, a buy transaction charge such as broker commissions, and a total for the buy proceeds to indicate the cash outflow for the buy transaction. Similarly, each sell transaction may include a sell price, a sell quantity, a sell transaction date and a sell transaction time. Additional sell transaction attributes may include a unique symbol to identify the security, a symbol to identify the stock exchange where the security was sold, a sell transaction charge such as Securities and Exchange Commission (SEC) fees and broker commissions, and a total for the sell proceeds to indicate the cash inflow for the sell transaction.

A position in a security may include a quantity of the security owed and not yet sold. Such a position may be referred to as a “long position.” Alternately, a position in a security may include a quantity of the security sold and not yet purchased. Such a position may be referred to as a “short position.” Selling a security to create a short position, or buying a security to create a long position may be referred to as “opening”, or “entering” the position. Buying a security to close a short position, or selling a security to close a long position may be referred to as “closing” or “exiting” the position.

In one embodiment, a trader may manage a portfolio of securities by using a Worst-In-First-Out (WIFO) method. For example, a trader may enter a sell order to sell a portion of a position in a particular security in the trader's portfolio. The sell order, with a quantity of N shares, may be filled by selling at least a portion of the securities in the portfolio. The WIFO method, in one embodiment, may select all or a portion of the number of shares of the highest priced buy transaction in the portfolio to fill the sell order. In another embodiment, one or more buy transactions may be sorted in a descending order according to the buy price of each buy transaction. Upon receiving an order to sell at least a portion of the portfolio of a security, the buy transactions of the security in the portfolio may be sold in the sorted order. In some embodiments, the trader may be given an option to cancel a sell transaction if the sell order quantity exceeds the available inventory.

In a similar manner, a trader may enter a buy order to exit at least a portion of a short position. The buy order, with a quantity of N shares, may be filled by buying at least a portion of the short securities in the portfolio. The WIFO method, in one embodiment, may select all or a portion of the number of shares of the lowest priced short sell transaction in the portfolio to fill the buy order. In another embodiment, one or more short sell transactions may be sorted in an ascending order according to the sell price of each short sell transaction. Upon receiving an order to exit at least a portion the position in the security, the short sell transactions of the security in the portfolio may be bought in the sorted order. In some embodiments, the trader may be given an option to cancel a buy transaction if the buy order quantity exceeds the available inventory of short securities.

In one embodiment, at least one reconciling entry may be made for a position closing (e.g. “exiting”) transaction. A reconciling entry may have a number of shares sold in a sell transaction that is equal to a number of shares from a buy transaction included in the portfolio. Alternately, a reconciling entry may have a number of shares bought in a buy transaction that is equal to a number of shares from a short sale transaction included in the portfolio. The computer system may provide a display to summarize the reconciled entries and may compute a net profit or loss for a buy/sell transaction cycle for a particular security. A profit or a loss on each buy/sell transaction cycle may be determined by computing the difference between the entry price and the exit price, multiplying the difference by the number of shares exited and deducting any costs or fees associated with the transaction cycle.

An embodiment of a computer-implemented method for managing a portfolio of securities may include generating the portfolio of securities. Generating the portfolio of securities may include executing entry transactions with the computer-implemented method and storing information regarding the executed entry transactions in the portfolio. Alternatively, generating the portfolio of securities may include receiving data associated with at least one entry transaction of at least one security. In this manner, the portfolio of securities may include at least one security, and each security may include an entry price. The method may also include receiving a position closing (e.g. “exit”) order for at least a portion of the portfolio. The exit order may include an exit price. In addition, the method may include determining a difference between the entry price and the exit price for each security of the portfolio. The method may further include selecting a security from the portfolio to be included in the portion. The selected security may have a determined difference between the entry price and the exit price that is less than or equal to a determined difference of each other security included in the portfolio. In this manner, long positions in securities in the portfolio may be closed by selling the securities with the highest purchase price before selling other securities in the portfolio which have lower purchase prices. Likewise, short positions in securities in the portfolio may be closed by buying the securities with the lowest sale price before buying other securities in the portfolio which have higher sale prices The method may also include selecting securities as described above until the exit order is filled.

In an embodiment, a computer-implemented method for managing a portfolio of securities may include receiving an exit order for a security. The portfolio of securities may include an exit transaction for the security. In such a case, an entry transaction may include an acquisition or sale of a quantity of the security. Each entry transaction may include an entry price. In addition, each entry transaction may also include an entry quantity, an entry transaction date, and an entry transaction time. The method may also include selecting an entry transaction from the portfolio. The selected entry transaction may have an entry price nearest an exit price of the exit order. The method may further include exiting at least a portion of the quantity of the security in the selected entry transaction. In addition, the method may include repeating the selecting and exiting steps of the method until the exit order may be filled, and/or until inventory is depleted.

In an embodiment, a system configured to manage a portfolio may include a network and a CPU coupled to the network. In addition, the system may include a system memory coupled to the CPU. The system memory may be configured to store one or more computer programs which may be executable by the CPU. The computer programs may be executable to implement any of the embodiments of the methods described above. In an additional embodiment, a carrier medium may include program instructions. The program instructions may be computer-executable to implement any of the embodiments of the methods described above.

### BRIEF DESCRIPTION OF THE DRAWINGS

FIG. 1 depicts an illustration of an embodiment of a computer system suitable for implementing various embodiments;

FIG. 2 depicts a schematic diagram of an embodiment of a wide area network suitable for implementing various embodiments;

FIG. 3 depicts one embodiment of securities transaction processing software using object oriented technology;

FIG. 4 depicts an illustration of a graphical user interface configured to display a real-time trading summary according to one embodiment;

FIG. 5 depicts a flowchart illustrating an embodiment of a method for managing a portfolio of securities; and

FIG. 6 depicts an illustration of a profit or loss summary displaying round-trip transactions according to an embodiment.

While the invention is susceptible to various modifications and alternative forms, specific embodiments thereof are shown by way of example in the drawings and are described in detail herein. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENTS

As used herein, a “trade price,” or price of a security generally refers to the price of a transaction for that security. If a trader is a purchaser or acquirer of a security, the trade price may also be referred to as a “buy price” or a “purchase price” of the security. If a trader is a seller of a security, the trade price may also be referred to as a “sell price.”

As used herein, a “bid price” generally refers to the price that a buyer may be willing to pay for a security at a given time. Conversely, an “ask price” may be the price that a seller may be willing to accept for a security at a given time. As used herein, a “market order” generally refers to a buy order or a sell order which is to be executed at the market price currently available. As used herein, a “limit order” is a buy order or a sell order which is to be executed at or below a specified price for a buy order and at or above a specified price for a sell order. The specified price may also be referred to as the limit price.

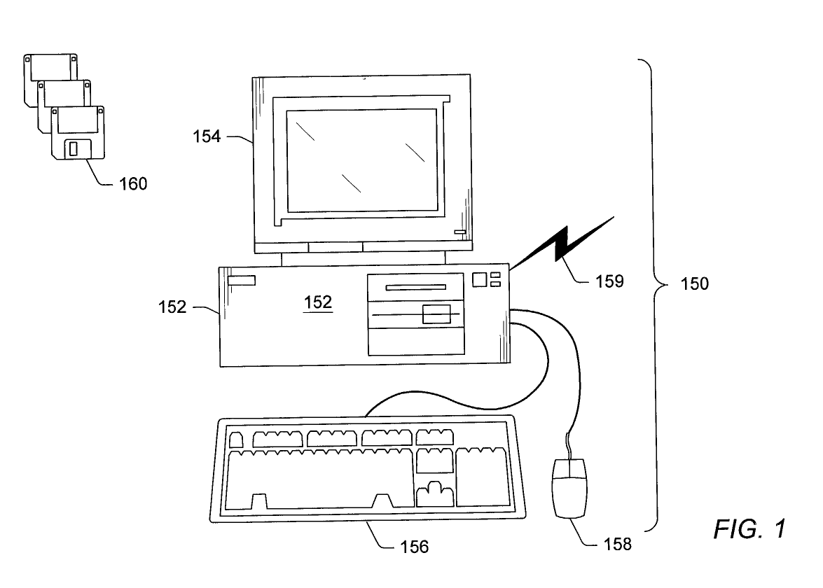

FIG. 1 illustrates an embodiment of computer system 150 which may be suitable for implementing various embodiments. Computer system 150 may include components such as CPU 152 and a memory medium such as floppy disks 160. The memory medium may be configured to store program instructions for computer programs. The program instructions may be executable by CPU 152. Computer system 150 may further include a display device such as monitor 154, an alphanumeric input device such as keyboard 156, and a directional input device such as mouse 158. Computer system 150 may be operable to execute the computer programs to implement a method for managing a portfolio of securities, also simply referred to as the computer system, as described herein. As described herein, one embodiment of computer system 150 may be used to process securities transactions. The term “computer system,” as used herein, generally describes the hardware and software components that in combination allow the execution of computer programs. Computer programs may be implemented in software, hardware, or a combination of software and hardware.

Computer system 150 may preferably include a memory medium on which computer programs according to various embodiments may be stored. The term “memory medium” may generally refer to an installation medium, e.g., a CD-ROM, DVD, or floppy disks 160, a computer system memory such as DRAM, SRAM, EDO RAM, Rambus RAM, etc., or a non-volatile memory such as a magnetic media, e.g., a hard drive, or optical storage. The memory medium may include other types of memory as well, or combinations thereof. In addition, the memory medium may be located in a first computer in which the programs are executed, or may be located in a second different computer, which connects to the first computer over a network. In the latter instance, the second computer may provide program instructions to the first computer for execution. Also, computer system 150 may take various forms, including a personal computer system, mainframe computer system, workstation, network appliance, Internet appliance, personal digital assistant (PDA), television system or other device. In general, the term “computer system” may be broadly defined to encompass any device having a processor, which may execute instructions from a memory medium.

The memory medium may preferably store software programs for processing securities transactions as described herein. The software program(s) may be implemented in various ways, including procedure-based techniques, component-based techniques, and/or object-oriented techniques, among others. For example, the software program may be implemented using ActiveX controls, C++ objects, JavaBeans, Microsoft Foundation Classes (MFC), or other technologies or methodologies, as desired. A CPU, such as host CPU 152, executing code and data from the memory medium may include a means for creating and executing the software program or programs according to the methods and/or block diagrams described below.

In FIG. 1, an embodiment of a securities transaction processing system may include computer system 150. In one embodiment, a securities transaction processing system using a network may also be referred to as a distributed securities services network. The securities transaction processing system may include hardware and software components that, in combination, may allow the execution of computer programs for processing securities transactions. The computer programs may be implemented in software, hardware, or a combination of software and hardware. A computer system's hardware may generally include a processor (CPU 152), memory media, and Input/Output (I/O) devices. As used herein, the term “processor” may generally describe the logic circuitry that responds to and processes the basic instructions that operate a computer system.

The software of a computer system (e.g., computer system 150) may include at least one operating system such as Windows NT, which is available from the Microsoft Corporation. The operating system may be a software program that manages and provides services to other software programs on the computer system. Software may also include one or more programs configured to perform various tasks on a computer system and various forms of data to be used by an operating system or other programs on the computer system. The data may include, but are not limited to, databases, text files, and graphics files. Software may be generally stored in non-volatile memory, such as floppy disks 160, or on an installation medium. A program may be copied into a volatile memory when running on the computer system 150. Data may be read into volatile memory as required by a program.

A server may be defined as a computer program that, when executed, provides services to other computer programs executing in the same or other computer systems. The computer system on which a server program is executing may also be referred to as a server, though it may contain a number of server and client programs. In the client/server model, a server is a program that awaits and fulfills requests from client programs in the same or other computer systems. A server that may be used to process securities transactions may be an Infocenter system. The Infocenter is a product of the ProTrader Securities Corporation.

As used herein, the term “channel” may generally describe any pathway that allows a user to interface with a computer system. Channels may include, but are not limited to, main office entry systems, branch office entry systems, kiosks, call centers, Internet systems, and electronic data interchange (EDI) systems. A channel may be a computer system. For example, computer system 150 shown in FIG. 1 may be a channel used for a securities data entry system, a branch office data entry system, a client computer system with a web browser or a component of the system used in a call center channel.

Each type of channel may require different implementation systems. For example, a kiosk entry system may use a touch-oriented visual screen. Special programming implementations may be needed to transfer data from the channel to one of several back-end computer systems. A channel may be implemented so that the channel may only be used for selected types of business transactions. For example, a kiosk system may be set up to only process certain business transactions such as providing pricing quotes for specified securities transactions. An office data entry system may use monitor 154, keyboard 156 and pointing device 158 (mouse) to allow data entry into a back-end server or a computer system 150. A call center may involve oral communication of data from a trader to a person who enters the data into a computer system through keyboard 156 and/or pointing device 158. Electronic data entry systems may transfer data from an external computer system to a back-end server.

Computer system 150 may further include a securities database (not shown) residing on an internal or an external storage device. The securities database may also be referred to as a repository. As used herein, a “database” may include a collection of information from which a computer program may select a desired piece of data. As used herein, a “securities database” may be used as a synonym for a “database” when included in or coupled to a securities transaction processing system. A securities transaction processing program, also referred to as application program software, may be stored in memory. As used herein, a “securities transaction processing program”, also referred to as securities program or securities software, may include a software program which is configured to execute securities transactions such as trading securities.

A securities transaction processing system may be used by a trader for various embodiments of a system and a computer-implemented method for managing a portfolio of securities. As used herein, a “trader” may generally refer to a securities organization that may provide or purchase securities products and/or support services. A securities organization may include a business or a corporation which may provide software tools to process security transactions received from traders. More particularly, the securities products may pertain to trading of securities. Trading securities may include, for example, purchasing a particular stock traded on the NASDAQ stock exchange.

As used herein, a “securities transaction” may generally be defined as a service provided by a securities organization to a securities trader. Examples of securities transactions may include, but may not be limited to, buying or selling stocks, buying or selling derivatives such as options, and buying or selling bonds. Examples of business transactions for a securities organization may include, but may not be limited to, adding or deleting trader accounts, tracking payables and receivables, establishing new policies/contracts, renewing policies/contracts, changing policies/contracts, canceling policies/contracts, providing pricing quote for potential investors, and processing trader transactions. Business transactions may also include services provided to traders, stock exchanges, employers, employees, broker agents, fraud investigators, and/or regulatory agencies.

In one embodiment, a securities transaction processing system may utilize object-oriented technology to process securities transactions. In another embodiment, processing of securities transaction may utilize traditional programming languages and databases to achieve the same result. Securities objects may be generally defined to represent or model real-world business features of securities products and services. Examples of securities objects may include, but are not limited to, objects representing the following: a security portfolio; a daily trading summary report; a settlement of a stock purchase; a buy order; securities company service facilities, customers, and employees; business processes such as opening a new securities trader application and calculation of commissions; interfaces to external securities organizations such as stock exchanges; temporal objects such as calendars, schedulers, and timers; and elemental data necessary to accomplish work tasks such as SEC fees, commission fees, etc.

A securities object may be represented on display screen 154 by a graphical icon or by a display listing properties of the securities object in graphic and/or alphanumeric format. In one embodiment, a securities object may be configured to gather and evaluate data for processing a securities trade and to automatically make decisions about the trade. One or more processing steps associated with processing of a trade may also be configured as one or more processing step objects. In one embodiment, display screen 154, which also may be referred to as a page or a display, may be associated with a processing step. The display screen may also be represented as an object. Each display screen object may include a property to point to a previous display and another property to point to a next display screen. Each property, e.g., the next display pointer on a display screen object, may be changed dynamically by using methods associated with the display screen object. One display screen object may serve as a starting point for processing a securities transaction. In one embodiment, the starting point for processing a securities transaction may include acquiring a user ID number or a trader account number from a trader.

In one embodiment, during processing of a securities transaction, a trader input may determine that processing the securities transaction requires execution of additional steps or tasks to continue processing of the securities transaction. The trader may provide inputs to the securities transaction-processing program at any display screen 154 associated with a step included in the initial screen. The securities claim processing software may dynamically modify the number of steps and/or the sequence of execution of the steps to complete processing of the securities transaction. A trader working at a client system may iterate through the processing steps and arrive at desired results for the securities transaction.

In one embodiment, upon startup, the program may provide a graphical user interface (GUI) which may display transaction processing-related information on display screen 154. The program may collect user inputs, which may be entered by the user using input devices 156 or 158, associated with a securities transaction. The program may perform a number of steps to complete the transaction. For example, if a user requests a transfer of a security from account A to account B, the computer system may process the user inputs, access a securities database, use the contents of the securities database to find the security in account A, withdraw the security from account A, deposit the security to account B and store the updated entries for accounts A and B in memory and/or securities database.

Computer system 150 may also include one or more user input devices, such as a keyboard 156, for entering data and commands into the securities transaction-processing program. Computer system 150 may also include one or more cursor control devices 158 such as a mouse which may use a cursor to modify a trader transaction entry displayed on display screen 154. In response to updating of the transaction entry by a trader, the securities transaction-processing program may store the updated transaction entry in the securities database.

In one embodiment, the object properties or attributes, attribute values, etc. may be constructed and stored during configuration of the securities transaction processing system. A domain may define the valid characteristics for a business property, attribute or a field, including, when appropriate, a list of the permissible values that the business field may contain. Configuration of the securities transaction processing system may occur at the time the securities system software program(s) and database(s) are initially installed and set up for processing securities transactions. Configuration of the securities transaction processing system may also occur after the initial configuration which may be performed during installation of the securities transaction processing system. A configuration of the securities transaction processing system that occurs after the initial configuration may be called a reconfiguration of the system. During reconfiguration, the object properties, attribute values, etc. defined or configured during the initial configuration may be modified or deleted, and new object properties, attribute values, etc. may be added to the securities transaction processing system. Some data may be processed differently in the securities transaction processing system after a reconfiguration of the securities system than before the reconfiguration.

In one embodiment, the securities transaction processing system may provide context-sensitive help. In one embodiment, the context-sensitive help may be automatically invoked and displayed on display screen 154. In one embodiment, the user may interactively invoke context-sensitive help by selecting one or more interface items on display screen 154 with cursor control device 158 such as a mouse. In one embodiment, the user may interactively invoke context-sensitive help by using input device 156. For example, the user may select one or more keys or a combination of keys on a keyboard to activate context-sensitive help. The context-sensitive help may be unique, although the same content may appear in one or more contents of the context-sensitive help.

In one embodiment, information for the context sensitive help may be accessed from a help database. The help database may include one or more documents that may be useful to a user in performing various steps associated with securities transaction processing. The help database may also include one or more tables that provide access to information in the documents. Each table may include a plurality of records or entries that may be used to locate help information in the one or more documents in the help database.

In one embodiment, a search interface for accessing the help database may be provided in the securities transaction processing system. A user may enter in the search interface one or more terms to be searched for in the help database. The user may then initiate the search for the one or more terms. The securities transaction processing system may then search the help database for entries including at least one of the one or more terms. The securities transaction processing system may locate one or more entries in the help database that include at least one of the one or more terms. The securities transaction processing system may then display information on display screen 154 from the located help database entries.

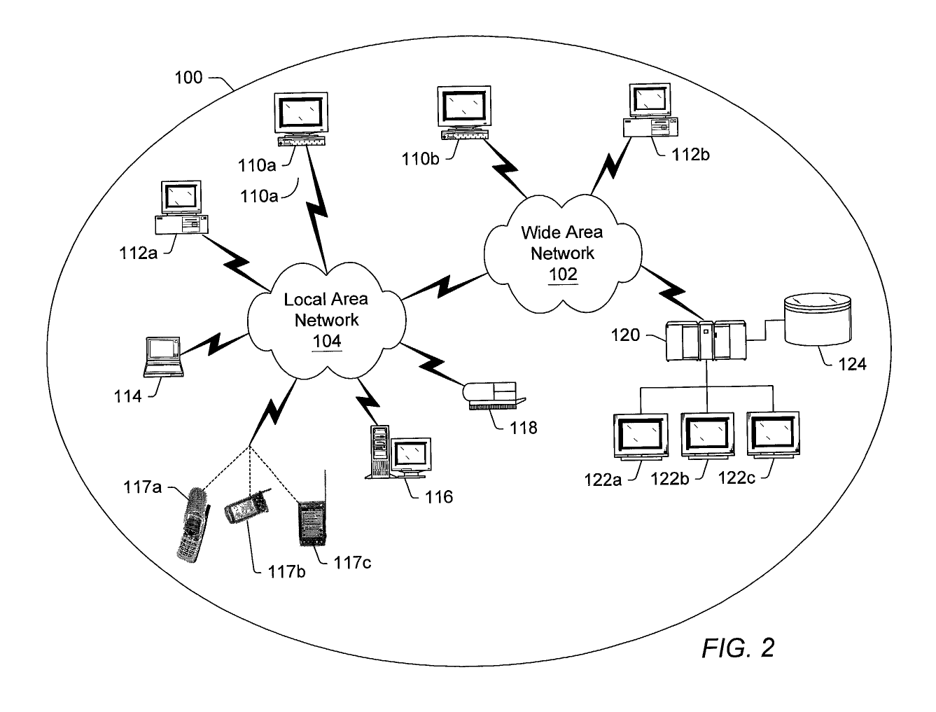

FIG. 2 illustrates a distributed or enterprise computing environment according to one embodiment. A distributed computing environment 100 may include a plurality of computer systems, which are interconnected through one or more networks. Although one particular embodiment is shown in FIG. 2, the distributed computing environment 100 may include a variety of heterogeneous computer systems and networks which are interconnected in a variety of ways and which run a variety of software applications and/or operating system software.

One or more local area networks (LANs) 104 may be included in environment 100. A LAN may be a network that spans a relatively small area. Typically, a LAN may be confined to a single building or a group of buildings. Each node (i.e., individual computer system or device) on a LAN preferably may have its own CPU with which it may execute programs, and each node may also be able to access data and devices anywhere on LAN 104. LAN 104 thus may allow many users to share devices (e.g., printers) as well as data stored on file servers. LAN 104 may be characterized by any of a variety of types of topology (i.e., a geometric arrangement of devices on the network), of protocols (i.e., rules and encoding specifications for sending data, and whether the network uses a peer-to-peer or client/server architecture), and of media (e.g., twisted-pair wire, coaxial cables, fiber optic cables, radio waves). As illustrated in FIG. 2, the distributed computing environment 100 may include one LAN 104. However, in alternate configurations the distributed computing environment 100 may include a plurality of LANs 104 which may be coupled to one another through wide area network (WAN) 102. WAN 102 may be a network that spans a relatively large geographical area. The Internet is an example of a WAN.

Each LAN 104 may include a plurality of interconnected computer systems and optionally one or more other devices, for example, one or more workstations 110a, one or more personal computers 112a, one or more laptop or notebook computer systems 114, one or more server computer systems 116, and one or more network printers 118. The optional one or more other devices may include personal digital assistant 117cand/or cellular telephones 117a and 117b which may be enabled to access the web. As illustrated in FIG. 2, LAN 104 may include one of each of computer systems 110a, 112a, 114, 116, and one printer 118. LAN 104 may be coupled to other computer systems and/or other devices and/or other LANs 104 through WAN 102.

One or more mainframe computer systems 120 may be included in distributed computing environment 100. As shown in FIG. 2, the mainframe 120 may be coupled to WAN 102. Alternatively, one or more mainframes 120 may be coupled to one or more LANs 104. As shown, mainframe 120 may be coupled to a storage device or file server 124 and mainframe terminals 122a, 122b, and 122c. Mainframe terminals 122a, 122b, and 122c may access data stored in the storage device or file server 124 coupled to or included in the mainframe computer system 120.

Distributed computing environment 100 may also include one or more computer systems, which may be connected to the distributed computing environment 100 through WAN 102. As illustrated in FIG. 2, one or more computer systems may include workstation 110b and personal computer 112b. In other words, environment 100 may optionally include one or more computer systems which may not coupled to distributed computing environment 100 through LAN 104. For example, the distributed computing environment 100 may include computer systems, which are geographically remote and connected to distributed computing environment 100 through the Internet.

In one embodiment, the enterprise or distributed computing environment 100 may include one or more computer systems configured to manage a portfolio of securities using a distributed securities services network. The one or more computer systems configured as securities transaction processing systems may be computer systems as illustrated in FIG. 1.

In a distributed securities services network, “front-end” and “back-end” are terms that may generally be used to describe program interfaces and/or services relative to the user of these interfaces and/or services. The user, e.g., a trader, may be a human being or a program. Users may directly interact with a front-end application. A back-end application or program may support various front-end services. The back-end application may interact directly with a front-end application. More typically, however, the back-end application may be a program called from an intermediate program that manages front-end and back-end activities.

As an example, a front-end application may interface directly with users and may forward requests to a remotely-located back-end program in another computer system, often referred to as a back-end server, to get requested data or perform a requested service. Relative to the client/server distributed computing model, a front-end system may be a client computer system (e.g., 112b) and a back-end system may be a server computer and/or a mainframe computer (e.g., 120). A back-end server may perform the actual execution of a transaction and may communicate the result to the front-end.

In one embodiment, securities transaction processing software (STPS) 30 may be implemented by using an object-oriented technology. The object-oriented technology may include, but may not be limited to, an object-oriented analysis and design, an object-oriented language and an object-oriented repository or a database. In one embodiment, STPS 30 may be implemented by using a legacy programming language, such as C. The object-oriented programs may interact with legacy code programs, and vice versa, to process securities transactions. In one embodiment, an object-oriented program may generate a new software module written in legacy code such as C.

Java™, Smalltalk and C++ are a few examples of object-oriented programming languages. In an object-oriented programming language, data and related methods may be grouped together or encapsulated to form an entity known as an object. The object is the fundamental building block of object-oriented programming. The data structures within an object may alternately be referred to as the object's state, its properties, its attributes, its fields, or its variables. In the Java™ Language, the data structures may normally be referred to as the variables of the object. In the Smalltalk object-oriented programming language, the data structures may be normally referred to as the properties of the object. The procedures that operate on the variables are referred to in Java™ and Smalltalk as the methods of the object. The list of methods, associated with the object, may also be referred to as the list of operations. Unlike traditional programming, in object-oriented programming the operations on the variables may only be performed via the methods of the object. The properties and methods of an object may be referred to as members of the object. Examples of a few methods that may be used when associated with a securities business object may include, but may not be limited to, a method for creating a new securities account, a method for renewing a trading contract, a method for selling a security from a portfolio based on market condition, a method for processing a buy order, and a method to transfer securities between two accounts.

In object-oriented programming, grouping together of the properties and methods within an object is referred to as encapsulation. When the properties relating to an object and the methods that may affect the object are encapsulated within the object, other entities usually do not have direct access to these data and procedures. The other entities instead call on the object itself to invoke its own methods and thereby operate on its own data. The encapsulation of the members of the object thereby provides some protection for the data within the object and prevents unauthorized, unwanted, or unintended manipulation of the data. This is sometimes referred to as data hiding. (The concept of data hiding through encapsulation should be distinguished from the hiding of properties in Java™ variable declarations, as explained in more detail below.)

In the Java™ language, if a user wants to hide the data within an object, the variable that contains the data is made private. Private properties within an object may only be accessed by the methods of the object. Because it may, in some cases, be inconvenient or impractical to require manipulation of certain data through the methods of the associated object, some properties may be made public. These public properties are directly accessible to entities other than the object with which the properties are associated. Thus, in practice, the properties within objects normally include some that are hidden or inaccessible and some that are public. In the Smalltalk language, properties are always private. However, one may achieve the effect of a public property by providing a so-called “getter” and “setter” method for this property. These methods then allow (indirect) access to the property from entities other than the object with which the property is associated.

All objects in an object-oriented programming system belong to a class, which may be thought of as a category of like objects, which describes the characteristics of those objects. Each object is created as an instance of the class by a program. The objects may therefore be said to have been instantiated from the class. The class sets out properties and methods for objects that belong to that class. The definition of the class does not itself create any objects. The class may define initial values for its properties, and the class normally defines the methods associated with the class (i.e., includes the program code which is executed when a method is invoked.) The class may thereby provide all of the program code that will be used by objects in the class, hence maximizing re-use of code, which is shared by objects in the class.

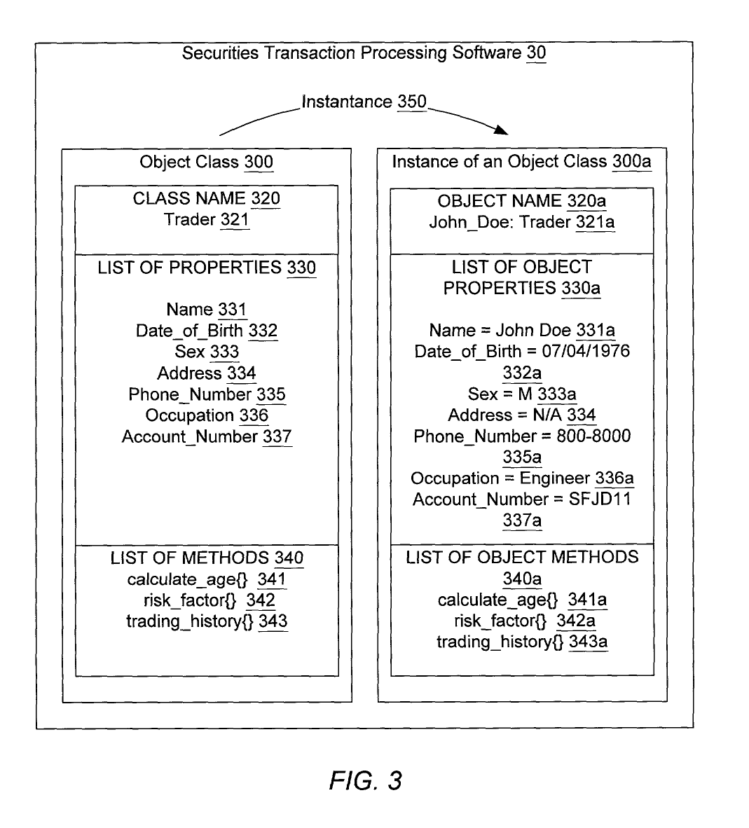

FIG. 3 illustrates one embodiment of a securities object class and an instance of the object class. Software to create object classes and instances of an object class may be included in the securities transaction processing software (STPS) 30. Illustrated in FIG. 3, is one embodiment of trader object class 300 and the creation of instance 350 of the trader object class i.e., trader object 300a. Trader class 300 may include a class identifier or name 320, such as trader 321. The trader class 300 may also include one or more properties 330 such as name 331, date_of_birth 332, sex 333, address 334, phone_number 335, occupation 336, and account_number 337. Trader class 300 may also include one or more methods 340 associated with class 300 such as calculate_age 341, risk_factor 342, trading_history 343, etc. For example, calculate_age method 341, when invoked, may calculate the current age of a trader. The method may return an argument containing the applicant's age. Creating instance 350 of trader class 300 may create trader object 300a. Specific properties 330a associated with the instantiated object 300a such as object ID=John_Doe 321a, name =John Doe 331a, sex=M 333a, etc. may be configured. Additional examples of object classes may include a securities class, an options class, a stock class, a trend class, etc.

In most object-oriented languages, classes may be hierarchical. That is, some classes may be subclasses of a higher class, also known as a superclass. In the Java™ language, the subclass is said to extend the superclass. Alternatively, the superclass is said to be extended by the subclass. For the purposes of this disclosure, a subclass is considered to extend all or any of the classes that are above it in the hierarchy. It may also be said that the subclass directly extends the class immediately above it in the hierarchy and indirectly extends higher classes in the hierarchy. For example, if a parent class is extended by a first subclass and that subclass is in turn extended by a second subclass, then the second subclass may be said to extend the parent class as well as the first subclass.

Problem solving may be accomplished by sending message(s) to objects. A message may name a method and may optionally include other arguments associated with the method. When a message is sent to an object, the method is looked up in the object's class to find out how to perform that operation on the given object. If the method is not defined for the object's class, it may be looked for in its superclass and so on up the class hierarchy until it is found or there is no higher superclass. Message sends may return a result object, which may be an error, as in the case where no superclass defines the requested method.

The hierarchical definition of classes and subclasses based on shared properties and methods is very useful. A subclass includes all the properties and methods in the class of which it is a member (its parent class). The subclass is said to inherit the properties and methods of its parent class. This property is useful in defining subclasses because only those properties and methods that do not appear in the parent class need to be defined in the subclass (although properties or methods which appear in the parent class may be redefined in the subclass.) This allows the code written in the parent classes to be re-used so that the programmer does not have to rewrite or cut and paste code into each new subclass. Methods that are defined in the parent class may, however, be redefined in subclasses. This is referred to as overriding or hiding the previously defined method(s). In Smalltalk, for example, when a class A has a subclass B which overrides a method x defined in A, then, when the message x is sent to an instance of class B, class B's implementation of method x will be used. In some object-oriented languages, by redefining a variable that has already been defined in a superclass, the programmer may hide the previously defined variable (which is distinct from the object-oriented data hiding concept inherent in encapsulation.) In some object-oriented languages, subclasses may inherit properties and methods from several classes. This is called multiple inheritance. If a subclass may only inherit from one parent class, this is called single inheritance. Inheritance may also be dynamic and/or shared. Specifically, dynamic inheritance refers to the ability to add, delete, or change parents from objects (or classes) at run-time. Multiple inheritances brings up the possibility for a class to appear as a parent more than once in a class graph (shared or repeated inheritance), and there is then a potential to share that class. The Java™ and Smalltalk languages are characterized by single inheritance, not multiple.

Hierarchical class structure also allows the programmer to take advantage of a property referred to as polymorphism. Polymorphism is a mechanism by which various objects may be handled in the same way externally, even though there are differences in the way they are handled internally. In other words, the interface that the different objects present to an external entity is the same for each object, but the details of each object's implementation may vary. This allows objects instantiated from different subclasses to be handled identically even though the subclasses are not identical. For example, assume that a drawing program implements a class for shapes, a subclass for circles, and a subclass for squares, each of which has a method called draw( ). While draw( ) will be implemented differently for the circle subclass and the square subclass, the drawing program does not have to know the details of how a shape will be drawn, or even which of the shapes is to be drawn. The drawing program simply calls the draw( ) method for the object to be drawn and the implementation defined in the object's class will be used.

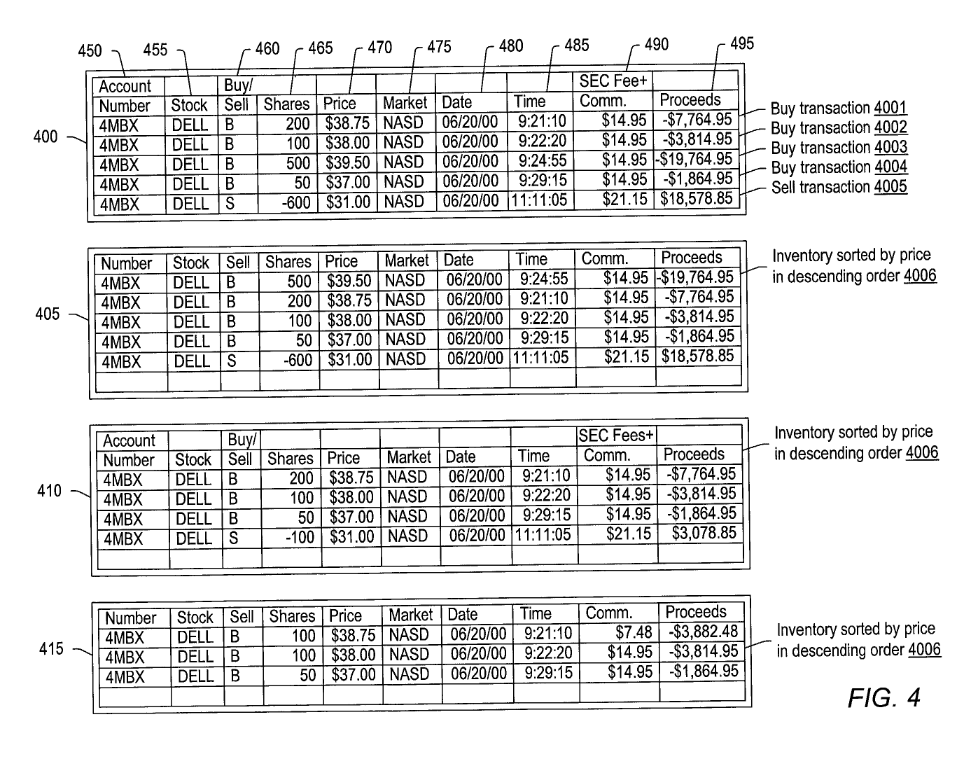

FIG. 4 illustrates one embodiment of a graphical user interface configured to display a real-time report of security transactions for a trader. The real-time report may include one or more displays (e.g., 400, 405, 410 and 415). In one embodiment, the report may group together transactions of a particular security. For example, the report may display buy and/or sell transactions of the particular type of security. The transactions may be listed in chronological order. Thus, a security transaction posted at 10 am may be displayed before a security transaction posted at 11 am of the same day.

As shown in display 400, various attributes or properties of the security transaction may be displayed in the top row (e.g., account number 450, stock 455, buy/sell 465, price 470, market 475, date 480, time 485, commission and fees 490 and proceeds 495). The values of each of the attributes for each security transaction may be displayed under their respective columns. Account number 450 may identify a specific account in which trading activity may occur. A trader may have ownership of one or more accounts. An account may be owned by at least one trader. In one embodiment, only individual traders may own an account. Stock symbol 455, may be used to identify a security. For example, Dell Computer Corporation common stock may be traded under the stock symbol DELL on the National Association of Securities Dealers (NASD) Market (i.e., the National Association of Securities Dealers Automated Quotations (NASDAQ) stock market).

A trader may include one or more types of securities in a portfolio of securities. The types of securities may include securities such as a stock, bond, treasury bills, cash and a Certificate of Deposit (CD). In one embodiment, transactions of one security, (e.g., transactions involving DELL stock), may be grouped together under one display. As shown in display 400, a plurality of buy and sell transactions may be shown. The plurality of transactions includes, for example, four separate buy transactions (e.g., buy transactions 4001, 4002, 4003 and 4004) and one sell transaction of DELL stock (e.g., sell transaction 4005). In one embodiment, display 400 may include hundreds, perhaps even thousands, of buy and/or sell transactions executed during the trading session for an active trader.

The type of transaction, e.g., a buy or a sell, may be identified in column 460. In one embodiment, the letter “B” may indicate a buy transaction and the letter “S” may indicate a sell transaction. The quantity of securities traded, e.g., the number of shares, may be identified in column 465. As used herein, a “share” may generally refer to an individual security, such as a single stock, a single bond, etc. The quantity is typically expressed as a positive integer. In one embodiment, the quantity may represent the actual number of shares traded. In one embodiment, the quantity may be represented as a multiple of 100 shares traded. For example, trading of 200 shares may be represented by a share quantity of 2. Column 470 displays the price at which the transaction (e.g., buy or sell order) took place. The price 470 may represent the buy price per share in a buy transaction. Conversely, the price may represent the sell price per share in a sell transaction. The price may include a fraction, e.g., 401/4 or a decimal, e.g., 40.25. An identifier in column 475 may identify the market in which the securities transaction took place. Examples of market identifiers include NASD for NASDAQ stock exchange, NYSE for the New York Stock Exchange and OTCBB or BB for Over The Counter Bulletin Board exchange service.

The date and time of each of transaction may be displayed in columns 480 and 485, respectively. As previously stated, the individual transactions may be displayed in chronological order, as is the case in display 400. Column 490 displays transaction costs such as fees and commissions. The proceeds column 495 displays net proceeds for each transaction. The net proceeds may be calculated by using a formula. For example, on a buy transaction the formula to calculate net proceeds may be (number of buy shares 465 multiplied by the share price 470) plus commissions 490. Alternatively, in a sell transaction, the formula to calculate net proceeds may be: (number of sell shares 465 multiplied by the share price 470) minus the SEC filing fees and commissions 490. For example, in display 400, buy transaction 4001 may have proceeds or a cash outflow of $7,764.95, i.e., −$7,764.95 as shown in column 495. This value may be computed by multiplying the number of shares bought (200) by the buy price ($38.75), then adding the commissions, (e.g., $14.95 or as applicable for that transaction), and showing a negative sign for a cash outflow. As an example of a sell transaction, sell transaction 4005 in display 400 may have a cash inflow of $18,578.85, i.e., +$18,578.85 as shown in column 495. This value may be computed by multiplying the number of shares sold (e.g., 600) by the price (e.g., $31.00), then subtracting SEC fees and commissions (e.g., $21.15), and showing a positive sign for cash inflow.

In one embodiment, a portfolio of securities may be transferred to a trader for managing the securities included in the portfolio. In one embodiment, a portfolio may include various previously purchased amounts of a security purchased at various prices (e.g., display 400). The portfolio thus may include a plurality of previously purchased shares of the security. Referring to display 400, prior to the sell transaction 4005, the number of shares available for a sell transaction is 850. The number of shares available for the sell transaction may be calculated by adding the number of shares included with buy transactions 4001, 4002, 4003 and 4004. The trader may elect to sell a portion of or all of the available shares in a sell transaction.

Various methods may be used to determine the order of closing of positions in a portfolio. The selected method may have an impact on the overall profitability of the portfolio. In one embodiment, positions in a security may be closed in the order that they were opened. For example, a sell order for securities owed, e.g., sell transaction 4005, may be filled by selecting the shares to be sold in a chronological order (e.g., First In First Out (FIFO)). For example, in display 400, sell transaction 4005 may be filled by using the FIFO method to select 600 shares to be sold in this transaction. In the FIFO method, 200 shares bought in buy transaction 4001 may be sold first since they we bought at the earliest time. Since an additional 400 shares are still required to fill the sell order, 100 shares from buy transaction 4002 may be sold next. In addition, 300 shares out of the 500 shares included in buy transaction 4003 may also be selected and sold to fill the sell order. The quantity of shares included in buy transaction 4003 may be updated to 200, i.e., 500 less 300 shares. Likewise, a FIFO method may also be used to close a short position in a stock.

Alternatively, a Last In First Out (LIFO) method may be used to exit a position in a security from the portfolio. For example, in display 400, sell transaction 4005 may be filled by selling 50 shares of buy transaction 4004, followed by selling 500 shares of buy transaction 4003, followed by selling 50 shares of buy transaction 4002 to fill the sell order of 600 shares using the LIFO method. The quantity of shares included with buy transaction 4002 may be updated to 50 shares, i.e., 100 less 50 shares.

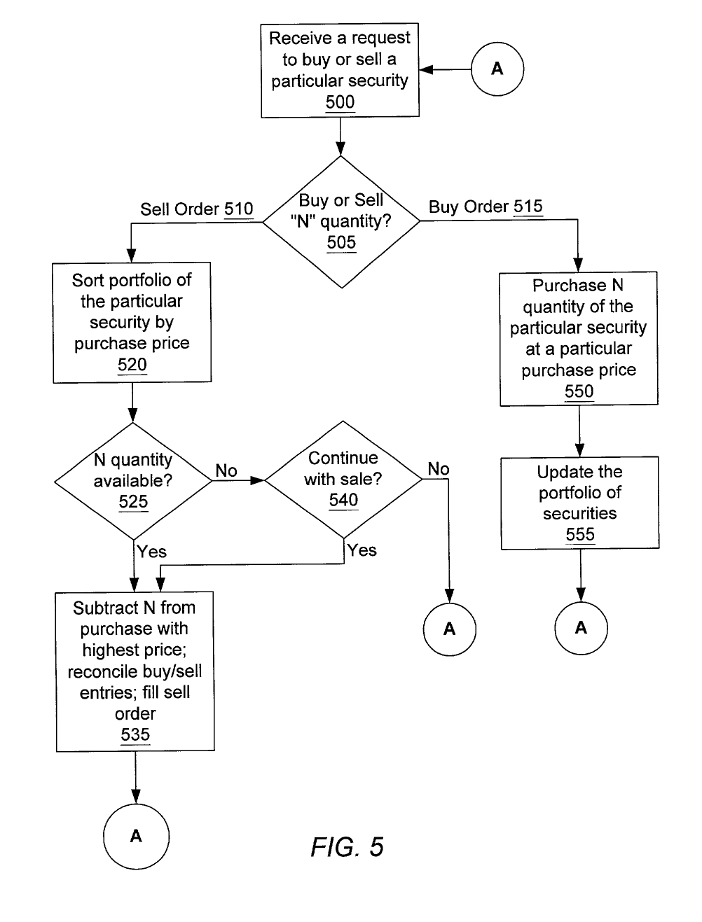

One embodiment of a computer-implemented method for managing a portfolio of securities may include selecting a particular sequence of securities to be exited in order to optimize profits for the trader. For example, the shares selected to be exited may be selected using a Worst-In-First-Out (WIFO) method such that exiting transaction 4005 may result in a maximum loss. The selection and sequence of exiting shares from the inventory to produce a maximum loss is described in FIG. 5.

With the WIFO method, loss is maximized up-front allowing for potential offsetting of gains on the exiting of other positions, or in other securities thereby reducing the tax burden on the trader. In one embodiment, a security transaction processing system as described in above embodiments may automatically select for sale the particular position(s) from an inventory to produce the maximum loss. In one embodiment, to produce a maximum loss, shares to be sold may be selected in descending order of the buy price from the portfolio. In such an embodiment, shares to be bought may be selected in ascending order of the sell price from the portfolio.

In one embodiment, a buy and/or sell transaction may be processed in one or more steps. Additional displays (e.g., display's 405, 410 and 415) may be used to display the trading summary during, before or after the one or more steps. For example, a sell transaction to sell 600 shares using the WIFO method may be processed by sorting the inventory of shares (e.g., display 405), displaying the trading summary after selling 500 of the 600 shares (e.g., display 410) and displaying the inventory after selling the balance of 100 of 600 shares (e.g., display 415).

FIG. 5 is a flowchart illustrating one embodiment of a computer-implemented method for managing a portfolio of securities. While the investment strategy for day traders may vary, many day traders may be interested in performing quick round-trips on a particular security. A “round-trip,” as used herein, may generally refer to an initial entering and a subsequent exiting of a position in a particular security. Other types of traders may opt for a longer-term investment strategy in which a position in a particular security may be held for months or years as opposed to minutes or hours. Day traders may often be interested in real-time calculations regarding a round-trip transaction (e.g., determining profit or loss).

In step 500, a securities transaction processing system as described in above embodiments may receive a request to trade a security. In one embodiment, the request to trade a security may include a request to buy (e.g., a buy order) or a request to sell (e.g., a sell order) the security which may be traded publicly on a stock exchange. In step 505, a determination of the direction of the trade request may be made. Possible directions may include a request to enter a position 515 or to exit a position 510. Either type of request may be presented as a buy order or a sell order.

If the trade request is entry order 515, then the method may include step 550. If the trade request is exit order 510, then the method may include step 520. In step 550, the transaction to enter a position with a quantity N of the security at an entry price may be executed. The trader may specify the entry price (e.g., a limit order) or the entry price may be determined by market conditions (e.g., a market order). After entering the position in the security, the portfolio of securities may be updated in step 555. For example, the number N of shares included in the purchased order may be added to the portfolio if a new long position is entered. After step 555, the securities transaction processing system may be ready to receive an additional transaction.

In step 520, the portfolio may be sorted by the entry price. Display 405 of FIG. 4 illustrates a sorted portfolio of a security in descending order according to the purchase price. Thus, the first entry in display 405 may include the highest purchase price of all buy transactions of a security in the portfolio (e.g., buy transaction 4003 with a price per share of $39.50). In one embodiment, sorting step 520 may be replaced or substituted by selecting a security of an entry transaction with the price per share from the portfolio nearest the exit price, as displayed in display 400 of FIG. 4. In one embodiment, a difference between the proposed exit price and the entry price for each of the securities or the entry transactions in the portfolio may be determined. The security or the entry transaction, which has the minimum difference, may be selected.

In step 525, it may be determined if a quantity N of a security requested to be exit is available in open positions in the portfolio. If quantity N of the security is available in the inventory, then processing may continue with step 535. Otherwise, processing may continue with step 540.

In step 535, a cumulative number of shares in open positions in the portfolio may be equal to or greater than the quantity N. For example, the cumulative number of shares may be calculated by adding the number of shares 465 of FIG. 4 associated with each of the entry transactions for the security (e.g., buy transactions 4001, 4002, 4003 and 4004) included in the portfolio. In display 400 of FIG. 4, the cumulative number of shares is 850 (i.e., 200+100+500+50=850). As such, the exit order quantity N, in this example, may be less than or equal to the cumulative number of shares (i.e., sell transaction 4005, shares 495, display 400 of FIG. 4). Therefore, the exit order may be filled with 250 shares remaining in the inventory (i.e., 850−600=250).

In one embodiment, an exit order for a quantity of N shares may be filled by using the WIFO method. If the quantity N is less than or equal to the number of shares in an open position in the portfolio having the entry price nearest the exit price, then the number of shares in that position may be reduced by the quantity N. For example, if the number of shares in the portfolio having the highest purchase price is 200 and quantity N =195, then the number of shares having the highest purchase price in the portfolio may be reduced to 5 (i.e., 200−195=5). If the quantity N is greater than the number of shares in an open position in the portfolio having the entry price nearest the exit price, then the exit order may be filled in multiple transactions. The remaining shares in the portfolio having the highest purchase price may be deducted from the quantity N through an iterative process until the sell order quantity N may be filled, or the inventory depleted. In some embodiments, if the available inventory is depleted, a new position may be opened in the opposite direction of the original position(s). That is, if a long position is held, and a sell order is placed where the sell quantity exceeds the number of shares available in open positions in the portfolio, then the excess shares in the sell quantity may open a new short position.

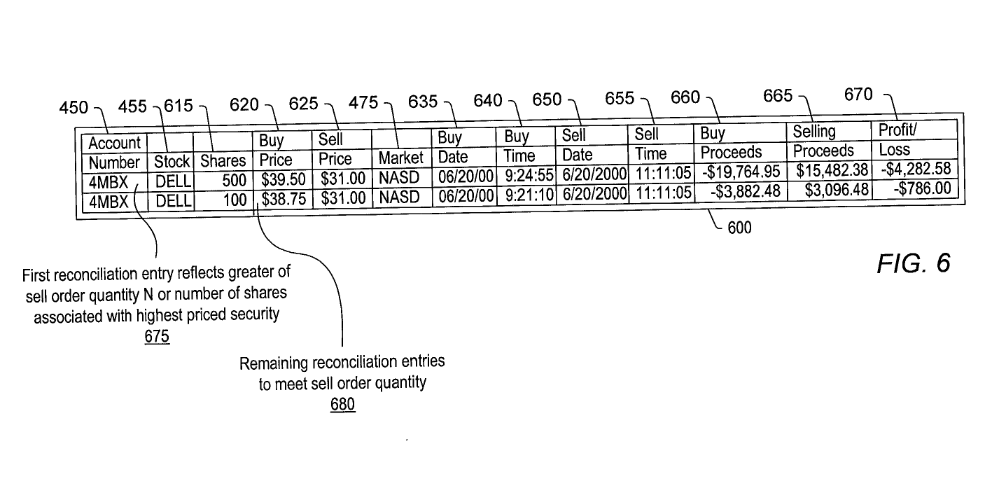

In display 405 of FIG. 4, the quantity N=600 and the number of shares in the portfolio having the entry price nearest the exit price (i.e., buy transaction 4003 with a buy price of $39.50) is 500. Since 500 shares are not sufficient to fill the exit order quantity N=600, additional shares from the portfolio have to be exited to fill the order. Reconciling entry 675 in display 600 of FIG. 6 that offsets the portfolio of shares having the highest purchase price (i.e., buy transaction 4003) may be made for an initial sell order of 500 shares. A reconciling entry may match the number of shares exited in an exit transaction with the same number of shares from an entry transaction of the portfolio. Reconciling entry 675 in FIG. 6 may sell 500 shares and deduct that number from the portfolio. Display 410 of FIG. 4 illustrates an updated portfolio of the securities. As shown, buy transaction 4003, which has the purchase price nearest the sell price, may be removed from the inventory. Calculations for a profit or a loss may be made to complete the reconciling transaction.

The process to fill the exit order (e.g., sell quantity N=600 shares) may continue in an iterative fashion for the remainder of the portfolio. In the example described above, an additional 100 shares are needed (i.e., 600−500=100) to fill the exit order. The remaining exit order quantity of 100 shown in display 410 of FIG. 4 may be filled by deducting 100 shares having the entry price nearest the exit price from the portfolio (i.e., 4006 in display 410 of FIG. 4). A reconciling entry for the 100 shares exited is illustrated in entry 680 in display 600 of FIG. 6. Display 415 of FIG. 4 illustrates the portfolio balance after exiting the remaining 100 shares.

In step 540, the trader may be presented with the information that the quantity N of the security requested to be exited is greater than the cumulative quantity of the security available in open positions in the portfolio. For example, such a situation may arise if a trader enters a exit order for 900 shares of a security when the inventory includes only 850 shares of the security. The trader may be given an option to exit all shares of the security available in the portfolio for the exit transaction or to abandon the exit transaction. Alternately, the trader may exit the entire 850 share inventory to exit an open position in the security and then enter a position in the opposite direction with 50 shares of the security.

FIG. 6 illustrates one embodiment of a profit or loss summary displaying round-trip transactions. The display may reconcile or match exiting orders with entry orders. For example, the sell order quantity N may be matched with the buy order quantity and may be removed from the portfolio. Upon recording the sale of N shares of a security, a reconciling entry which matches the number of shares sold to the number of shares purchased may be made, as shown in display 600 of FIG. 6. A reconciling statement may also display the profit or loss on the round-trip, i.e., a buy/sell cycle for N shares of a security.

The reconciling statement display 600 may include one or more entries 675 and 680 for each exit order. The display 600 may have a single reconciling entry if the number of shares in one entry transaction having the entry price nearest the exit price is equal to or greater than the exit order quantity N. An example of a sell order entry is shown as sell transaction 4005 in display 400 of FIG. 4. If the number of shares available in the first buy transaction in the sorted portfolio display 405 is greater than or equal to the sell order quantity N, then the reconciling statement display may include only one reconciling entry. In the example shown in display 600, the sell order quantity N=600 exceeds the number of shares included in the buy transaction having the highest purchase price, (i.e., buy transaction 4003 with shares 465 equal to 500 as shown in display 400 of FIG. 4). The first reconciling entry 675 reconciles the exiting of 500 shares out of 600 shares specified in the exit order.

The reconciling entries (e.g., 675 and 680) may display values associated with one or more attributes or properties of each reconciling transaction. The attributes displayed may include columns similar to those shown in display 400 of FIG. 4 along with columns such as an account number (450 of FIG. 4), a stock symbol (455 of FIG. 4), number of shares 615 (the lower of exit order quantity N or the number of shares 465 in the portfolio having the entry price nearest the exit price), buy price 620, sell price 625, market identifier (475 of FIG. 4), buy date 635, buy time 640, sell date 650 and sell time 655. Proceeds from the buy transaction, e.g., buy proceeds 660, may be determined by multiplying number of shares 615 by buy price 620 and adding any applicable transaction fees, such as commission fees. The negative sign indicates a cash outflow. For example, buy proceeds 660 of −$19,764.95 may be calculated by multiplying number of shares 615, i.e., 500 shares, by buy price 620, i.e., $39.50,=$19,750, adding a commission fee of $14.95 and assigning a negative sign to indicate a cash outflow to arrive at the buy proceeds 660 of −$19,764.95. Selling proceeds 665 may be calculated by multiplying number of shares 615 by sell price 625 and subtracting any SEC fees and/or commissions to calculate sell proceeds 665. For example, sell proceeds 665 of $15,482.38 may be calculated by multiplying number of shares 615, i.e., 500, by sell price 625, i.e., $31.00, subtracting prorated SEC fees and commissions i.e., $21.15*(500/600), and assigning a positive sign for a cash inflow to arrive at sell proceeds 665 of $15,482.38. A positive sign for the sell proceeds indicate a cash inflow. A net profit or loss 670 may be calculated by combining buy proceeds 660 and sell proceeds 665. For example, first reconciliation entry 675 produces a net loss of $4,282.58, which may be calculated by combining buy proceeds 660, i.e., −$19,764.95, with sell proceeds 665, i.e., $15,482.38, to arrive at −$4,282.58.

In the example illustrated in FIG. 6, 500 of the 600 shares sold are matched with the purchase made at $39.50 per share. The selling of the next 100 shares may be displayed in entry 680 in display 600 of FIG. 6. In display 410 of FIG. 4, the number of shares 465 shown having the purchase price nearest the sell price is 200. After selling the 100 shares to meet the sell order quantity of 600, the number of shares 465 is reduced to 100 in the portfolio as shown in display 415 of FIG. 4.

The examples above generally refer to entering positions through buy transactions and exited positions through sell transactions. However, as previously noted, a position in a security may be entered by a buy transaction if the position is a long position, or by a sell transaction if the position is a short position. Likewise, a position in a security may be exited with a buy transaction if the position is a short position, and exited by a sell transaction if the position is a long position. The principles of the embodiments described are applicable for short positions as well as long positions. In the case of exiting a short position, the “worst” position may be selected by sorting the open short positions in ascending order of sale price. Thus, the shares sold at the lowest price may be selected. Alternately, the shares of the security with the smallest difference between the sale price and the purchase price may be selected.

Various embodiments further include receiving or storing instructions and/or data implemented in accordance with the foregoing description upon a carrier medium. Suitable carrier media may include storage media or memory media such as magnetic or optical media, e.g., disk or CD-ROM, as well as signals such as electrical, electromagnetic, or digital signals, conveyed via a communication medium such as networks 102 and/or 104 (shown in FIG. 2) and/or a wireless link.

It will be appreciated to those skilled in the art having the benefit of this disclosure that this invention is believed to provide methods and systems for managing a portfolio of securities. Further modifications and alternative embodiments of various aspects of the invention will be apparent to those skilled in the art in view of this description. For example, the method and systems may also be used for selling manufactured products and goods such as paper, food, and textiles. It is intended that the following claims be interpreted to embrace all such modifications and changes and, accordingly, the specification and drawings are to be regarded in an illustrative rather than a restrictive sense.

What is claimed is:

1. A computer-implemented method for managing a portfolio of securities, comprising:
providing a portfolio of securities, wherein the portfolio of securities comprises at least one position in at least one security, each position comprising a quantity of shares of each of the at least one securities bought or sold and an entry price;
receiving an exit order to exit at least a portion of at least one position in a security, wherein the exit order comprises an exit price for the security;
determining a potential profit comprising a difference between the entry price and the exit price for each share of the security in the portfolio; and
selecting one or more shares of the security from the portfolio to be included in the portion exited, wherein the selected shares comprises a potential profit less than or equal to a potential profit of each share of the security not selected.

2. The method of claim 1, wherein receiving the exit order, determining the potential profit and selecting the one or more shares occurs in approximately real-time.

3. The method of claim 1, wherein the at least one security is selected from the group consisting of stocks, options contracts, futures, bonds, mutual funds and cash.

4. The method of claim 1, wherein the exit price comprises a bid price or an ask price.

5. The method of claim 1, wherein the entry price comprises a purchase price or a sale price.

6. The method of claim 1, wherein software is operable to implement the method, wherein the software is executable on a computer, and wherein the computer is coupled to a computer network.

7. The method of claim 1, wherein software is operable to implement the method, wherein the software is executable on a computer, wherein the computer is coupled to a computer network, and wherein the computer network comprises the Internet.

8. The method of claim 1, wherein each of the at least one positions comprises a date of entry and a time of entry.

9. The method of claim 1, wherein providing the portfolio of securities comprises receiving configuration data, wherein the configuration data identifies at least the entry price, an entry quantity, a date of entry and a time of entry for each of the at least one positions.

10. The method of claim 1, wherein the exit order further comprises an exit quantity.

11. The method of claim 1, wherein receiving the exit order comprises receiving configuration data, and wherein the configuration data identifies at least an exit price and an exit quantity.

12. The method of claim 10, further comprising:
determining a profit or loss for the portion exited by determining a difference between the exit price and the entry price of the portion; and
multiplying the difference by the exit quantity associated with the exit order.

13. The method of claim 10, wherein the portion exited comprises a quantity of shares, the method further comprising:
subtracting the quantity of shares exited from the exit quantity to determine an additional exit quantity;
altering the portfolio of securities, wherein altering the portfolio comprises removing the quantity of shares exited from the portfolio; and
altering the exit order such that the exit quantity equals the additional exit quantity if the additional exit quantity is greater than zero.

14. The method of claim 13, further comprising:
receiving the altered exit order;
determining a potential profit comprising a difference between the entry price and the exit price for each of the shares of the security in the altered portfolio; and
selecting one or more shares of the security from the altered portfolio to be included in the portion exited, wherein the selected shares comprise a potential profit less than or equal to a potential profit of each share of the security not selected.

15. A computer-implemented method for exiting at least a portion of a position in a security, comprising:
receiving data associated with the security, wherein the received data comprises an entry price of the security;
storing the received data in a portfolio of securities;
sorting the received data in the portfolio of securities according to the entry price; and
exiting at least a portion of a position in the security according to the order of the sorted received data in the portfolio.

16. The method of claim 15, wherein the entry price comprises a purchase price, and the sorting comprises sorting the received data in the portfolio in order of descended purchase price.

17. The method of claim 15, wherein the entry price comprises a sales price, and the sorting comprises sorting the received data in the portfolio in order of ascending sales price.

18. The method of claim 15, wherein exiting the position in the security occurs in approximately real-time.

19. The method of claim 15, wherein the security is selected from the group consisting of stocks, options contracts, futures, bonds, mutual funds, and cash.

20. The method of claim 15, wherein software is operable to implement the method, wherein the software is executable on a computer, and wherein the computer is coupled to a computer network.

21. The method of claim 15, wherein software is operable to implement the method, wherein the software is executable on a computer, wherein the computer is coupled to a computer network, and wherein the computer network comprises the Internet.

22. The method of claim 15, wherein the received data further comprises an entry quantity, a date of entry and a time of entry.

23. The method of claim 15, wherein the received data further comprises configuration data, and wherein the configuration data identifies at least an entry price, an entry quantity, a date of entry and a time of entry of the security.

24. The method of claim 15, wherein exiting the position in the security comprises one or more exit transactions, wherein each of the one or more exit transactions comprises an exit price, and wherein each of the one or more exit transactions occurs in the order of the sorted portfolio.

25. The method of claim 24, wherein each of the one or more exit transactions further comprises an exit quantity.

26. The method of claim 15, further comprising receiving data associated with an exit order the received data, wherein the received data comprises configuration data, and wherein the configuration data identifies at least an exit price and an exit quantity.

27. The method of claim 25, further comprising:
determining a profit or loss for the exit of at least a portion of the position in the security, wherein determining the profit or loss comprises determining a difference between the entry price and the exit price of the security; and
multiplying the difference by the exit quantity associated with the exit of at least a portion of the position in the security.

28. The method of claim 27, further comprising:
subtracting the quantity of shares exited from the exit quantity to determine an additional exit quantity;
altering the portfolio, wherein altering the portfolio comprises removing one or more exited shares from the portfolio; and
altering the exit quantity such that the exit quantity equals the additional exit quantity if the additional exit quantity is greater than zero.

29. The method of claim 28, further comprising:
receiving the altered exit order;
determining a potential profit comprising a difference between the entry price and the exit price for each of the shares of the security in the altered portfolio; and
selecting one or more shares of the security from the altered portfolio to be included in the portion exited, wherein the shares are selected according to the sorted order of the altered portfolio.

30. A computer-implemented method for managing a portfolio of securities, comprising:
providing a portfolio of securities, wherein the portfolio of securities comprises at least one position in a security, each position comprising a quantity of shares of the security bought or sold and an entry price for the security upon entering the position;
sorting the at least one position in a security in the portfolio according to the entry price; and
exiting at least one position in at least one security according to the order of the sorted portfolio.

31. The method of claim 30, wherein the at least one postion in a security comprises a long position, and the sorting comprises sorting the at least one position in order of descended purchase price.

32. The method of claim 30, wherein the at least one postion in a security comprises a short position, and the sorting comprises sorting the at least one position in order of ascending sell price.

33. A system configured to manage a portfolio of securities, comprising:
a computer network;
a CPU coupled to the computer network; and
a system memory coupled to the CPU, wherein the system memory is configured to store one or more computer programs executable by the CPU, and wherein the computer programs are executable to implement a method for managing the portfolio of securities, the method comprising:
providing a portfolio of securities, wherein the portfolio of securities comprises at least one position in at least one security, each position comprising a quantity of shares of each of the at least one securities bought or sold and an entry price;
receiving an exit order to exit at least a portion of at least one position in a security, wherein the exit order comprising an exit price for the security;
determining a potential profit comprising a difference between the entry price and the exit price for each share of the security in the portfolio; and
selecting one or more shares of the security from the portfolio to be included in the portion exited, wherein the selected shares comprises a potential profit less than or equal to a potential profit of each share of the security not selected.

34. A carrier medium comprising program instructions, wherein the program instructions are computer-executable to implement a method for managing a portfolio of securities, the method comprising:
providing a portfolio of securities, wherein the portfolio of securities comprises at least one position in at least one security, each position comprising a quantity of shares of each of the at least one securities bought or sold and an entry price;
receiving an exit order to exit at least a portion of at least one position in a security, wherein the exit order comprising an exit price for the security;
determining a potential profit comprising a difference between the entry price and the exit price for each share of the security in the portfolio; and
selecting one or more shares of the security from the portfolio to be included in the portion exited, wherein the selected shares comprises a potential profit less than or equal to a potential profit of each share of the security not selected.

35. A computer-implemented method for managing a portfolio of securities, comprising:
(a) receiving an exit order for a security, wherein the portfolio of securities comprises at least one entry transaction, wherein the entry transaction comprises an acquisition or sale of a quantity of the security, and wherein each entry transaction comprises an entry price;
(b) selecting an entry transaction from the portfolio, wherein the entry transaction selected comprises the entry price nearest an exit price of the exit order;
(c) exiting at least a portion of the quantity of the security in the selected entry transaction; and
(d) repeating (b) and (c) until the exit order is filled.

36. The method of claim 35, wherein receiving the entry order, selecting the entry transaction and exiting at least a portion of the quantity of the security in the selected entry transaction occurs in approximately real-time.

37. The method of claim 35, wherein the security is selected from the group consisting of stocks, options contracts, futures, bonds, mutual funds, and cash.

38. The method of claim 35, wherein software is operable to implement the method, wherein the software is executable on a computer system, and wherein the computer system is coupled to a computer network.

39. The method of claim 35, wherein software is operable to implement the method, wherein the software is executable on a computer system, wherein the computer system is coupled to a computer network, and wherein the computer network comprises the Internet.

40. The method of claim 35, wherein each of the at least one entry transactions further comprises an entry quantity, an entry transaction date and an entry transaction time.

41. The method of claim 35, wherein exiting comprises at least one exit transaction, wherein each of the at least one exit transaction comprises an exit price and an exit quantity.

42. The method of claim 41, further comprising:
determining a profit or loss on the exited portion by determining the difference between the exit price and the entry price of the selected entry transaction; and
multiplying the difference by the exit quantity associated with the at least one exit transaction.
